(19) United States
(12) Patent Application Publication
(10) Pub. No.: US 2002/0155274 A1
(43) Pub. Date: Oct. 24, 2002

(54) Polyolefin film/foam/film composite materials and methods for producing same

(76) Inventors: Natarajan S. Ramesh, Grapevine, TX (US); Lewis D. Smith, Arlington, TX (US)

Correspondence Address: CRYOVAC, INC., SEALED AIR CORP, P.O. BOX 464, DUNCAN, SC, 29334, US

(21) Appl. No.: 09/782,337

(22) Filed: Feb. 13, 2001

(51) Int. Cl. B32B 27/00

(52) U.S. Cl. 428/317.1; 428/317.3; 428/319.9

(57) ABSTRACT

The present invention is directed to composite flooring materials and methods for making the same. The composite materials have a first film adhered to a first surface of a polyolefin foam sheet and a second film adhered to a second surface of the polyolefin foam sheet. At least one edge of the second film extends beyond a corresponding edge of the polyolefin foam sheet.

### FIELD OF THE INVENTION

The present invention is directed to polyolefin film/foam/film composite materials and methods for producing the same. More specifically, this invention relates to polyolefin film/foam/film composite materials that are useful as flooring underlayments for laminate floors and methods for producing the same.

### BACKGROUND OF THE INVENTION

Laminate floors are relatively new flooring materials that may be used in place of more traditional materials, such as wood, tile, or vinyl, but are typically constructed to resemble either wood or tile. Laminate floors generally comprise two or more layers, including a top or surface layer and a core layer. The surface layer is a protective, wear-resistant layer which may contain aluminum oxide particles or other materials that form a hard, durable surface. The core layer to which the surface layer is bonded may comprise high density fiberboard. This wood-based material may include a tongue-and-groove design to allow pieces of the flooring to be bonded together with an adhesive. The laminate may also include a bottom layer to help balance the flooring and add strength.

Laminate floors are commercially available from various manufacturers in the flooring business, and are designed to be installed as a floating floor, i.e., not nailed or glued to the subfloor. Instead, the flooring is applied over a floor “underlayment,” which is typically a thin layer of polyethylene foam (e.g., less than 0.1 inch), to provide cushioning and sound reduction. When laminate flooring is applied on a concrete sub-floor, it is important that the underlayment also provide a barrier to the passage of water vapor therethrough so that water vapor from the concrete subfloor does not cause the core/fiberboard layer of the laminate floor to deteriorate from rotting. While polyethylene (PE) foam provides excellent cushioning and sound reduction, the water vapor transmission rate (WVTR) through polyethylene foam is higher than desired for floor underlayment applications on concrete sub-floors. Further, while many laminate flooring materials include a bottom layer, this layer generally does not provide a barrier to the passage of water vapor.

It has previously been proposed to adhere a sheet of polyethylene film to a sheet of polyethylene foam in order to provide a composite structure having a lower WVTR than a sheet of polyethylene foam alone. Although WVTRs of about 0.6 grams/100 in² per 24 hours (measured at 100° F. and 90% relative humidity) or less can be obtained using polyethylene foam/film composites, there is a continued need for floor underlayments having even lower WVTRs. In addition, it would be desirable to achieve such a low WVTR with a lower film thickness, thereby using less resin to make the film and, as a result, reducing the cost of the floor underlayment composite.

Further, conventional polyethylene foam/film underlayments have proven to have less abuse- and tear-resistance than would otherwise be desired, as installation of such underlayments often take place in rather rough building construction environments where the PE foam component of the underlayment can be too easily torn or punctured, thereby compromising the integrity of the water vapor barrier that the PE film is otherwise intended to provide. It has been determined that an increase in the tensile strength and tear initiation resistance of the film component of foam/film underlayment composites would have a beneficial impact on the abuse- and tear-resistance of the underlayment material.

Thus, there is the need in the art for improved composite materials that are useful as flooring underlayments for laminate floors and methods for making the same. The composite materials should preferably provide good vapor barrier properties, such as low moisture vapor transmission rates. In addition, the composite materials should provide a good combination of mechanical properties, such as tensile strength and tear resistance.

### SUMMARY OF THE INVENTION

The present invention provides composite materials that are useful as flooring underlayments for laminate floors and methods for producing the same. The composite materials of the present invention provide improved moisture barrier properties, such as moisture vapor transmission rates, as compared to the known composite materials. In addition, the composite materials of the present invention have a good combination of mechanical properties, including tensile strength and tear resistance. The composite materials of the present invention can also provide the combination of good moisture barrier and mechanical properties while utilizing less resin material than the known composites, thereby enabling the beneficial combination of properties to be obtained at reduced costs. Further, the foam is sandwiched between two film layers so that the composite is more durable and resistant to rough handling of the product during floor installation.

In one of its aspects, the present invention relates to composite materials having a foam sheet, a first film adhered to a first surface of the foam sheet; and a second film adhered to a second surface of the foam sheet. At least one edge of the second film extends beyond a corresponding edge of the foam sheet. In one embodiment, the foam sheet is composed of a polyolefin, such as a low density polyethylene, a medium density polyethylene, or a high density polyethylene. Preferably, the foam sheet has a density of between about 1 and about 6 pounds/ft³ and a thickness of between about 0.001 and about 2 inches.

The first film preferably comprises a polyolefin, such as a low density polyethylene, a metallocene based polyethylene, a medium density polyethylene, a high density polyethylene, or a biaxially oriented polypropylene. The first film preferably has a thickness of not more than about 0.001 inches. In one particular embodiment, the first film comprises a film layer and a bonding layer. The bonding layer is preferably composed of propylene/ethylene copolymers, ethylene-propylene terpolymers (e.g., EPDM), ethylene-butylene random copolymers, polyethylenes ranging in density from about 0.91 to about 0.96 g/cc, metallocene-catalyzed plastomers and elastomers, ultra low density ethylene/octene copolymers (ranging in density from about 0.87 to about 0.913 g/cc), ionomers, natural rubbers, styrene-butadine-stryrene copolymers, styrene-isoprene-styrene copolymers, acrylics, ethylene/vinyl acetate copolymers, ethylene/vinyl alcohol copolymers, flourinated ethylene-propylene copolymers, elastomeric copolymers of ethylene and propylene (e.g., EPR), butyl rubbers, ABS, chlorinated polyethylenes, PVDC, ACS acrylonitrile-chlorinated polyethylenes, or HIPS (high impact polystyrenes).

The second film preferably comprises a polyolefin, such as a low density polyethylene. The second film preferably has a thickness of between about 0.001 inches and about 0.008 inches. In one particular embodiment, the second film comprises a film layer and a bonding layer. The bonding layer is preferably composed of propylene/ethylene copolymers, ethylene-propylene terpolymers (e.g., EPDM), ethylene-butylene random copolymers, polyethylenes ranging in density from about 0.91 to about 0.96 g/cc, metallocene-catalyzed plastomers and elastomers, ultra low density ethylene/octene copolymers (ranging in density from about 0.87 to about 0.913 g/cc), ionomers, natural rubbers, styrene-butadine-stryrene copolymers, styrene-isoprene-styrene copolymers, acrylics, ethylene/vinyl acetate copolymers, ethylene/vinyl alcohol copolymers, flourinated ethylene-propylene copolymers, elastomeric copolymers of ethylene and propylene (e.g., EPR), butyl rubbers, ABS, chlorinated polyethylenes, PVDC, ACS acrylonitrile-chlorinated polyethylenes, or HIPS (high impact polystyrenes).

The first and/or second films are optionally stretch-oriented in at least two directions. When the first or second films are stretch oriented, the films preferably have an orientation ratio of at least about 2 in both of the two directions.

The composite material of the present invention may also have an optional adhesive positioned along at least a portion of the edge of the second film that extends beyond the corresponding edge of the foam sheet. A release liner is optionally applied to the adhesive.

In another of its aspects, the present invention relates to a method for making a composite material wherein a first film is adhered to a first surface of a foam sheet and a second film is adhered to a second surface of the foam sheet. The second film is arranged with respect to the foam sheet such that at least one edge of the film extends beyond a corresponding edge of the foam sheet. In one embodiment, the first and second films are heat laminated to the foam sheet. Bonding layers are optionally interposed between the first and/or second films and the foam sheet.

### BRIEF DESCRIPTION OF THE DRAWING

The numerous objects and advantages of the present invention may be better understood by those skilled in the art by reference to the accompanying detailed description and the following drawing, in which:

FIG. 1 is an elevational, cross-sectional view of a composite structure in accordance with the present invention;

FIG. 2 is an elevational, cross-sectional view of the composite structure illustrated in FIG. 1 used as a floor underlayment; and

FIG. 3 is a schematic view of a preferred process for making the composite structure shown in FIG. 1.

### DETAILED DESCRIPTION OF THE INVENTION

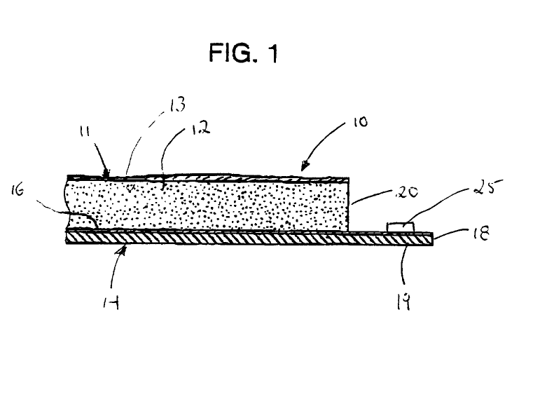

Referring now to FIG. 1, a composite structure 10 in accordance with the present invention will be described. Such composite structure includes a foam sheet 12 comprising polyolefin, a first film sheet 11 adhered to a first surface 13 of the foam sheet 12, and a second film sheet 14 adhered to a second surface 16 of the foam sheet 12. Second film sheet 14 has a larger surface area than the foam sheet such that at least one edge 18 of the film sheet extends beyond a corresponding edge 20 of foam sheet 12. In this manner, film sheet 14 has an extended region 19 that extends beyond edge 20 of foam sheet 12. The extended region 19 enables adjacent composite structures to be placed to provide a continuous water vapor barrier, as described in detail below.

Polyolefin foam sheet 12 preferably comprises polyethylene homopolymer or copolymer. Polyolefin foams, particularly polyethylene (PE) foams, and methods for manufacturing such foams are well known in the art. See, e.g., U.S. Pat. Nos. 5,348,984 (Lee), 5,462,974 (Lee), and 5,667,728 (Lee), the disclosures of which are incorporated herein by reference thereto.

Examples of useful polyethylene homopolymers include low density polyethylene (LDPE) and high density polyethylene (HDPE). Polyethylene copolymers may include, e.g., homogeneous ethylene/alpha-olefin copolymers (i.e., metallocene/single-site catalyzed copolymers of ethylene and, e.g., one or more C₃ to C ₁₀ alpha-olefin comonomers) or heterogeneous (i.e., Ziegler-Natta catalyzed) ethylene/alpha-olefin copolymers. A preferred polyethylene is low density polyethylene (LDPE) having a melt flow index ranging from about 1 to about 40 and a density ranging from about 0.915 g/cc to about 0.930 g/cc.

Foam sheet 12 may have any desired thickness to suit the intended application as a floor underlayment, preferably ranging, e.g., from about 0.004 to about 2 inches, more preferably from about 0.01 to about 1 inch, and most preferably from about 0.05 to about 0.5 inch. The foam may have any desired density, ranging, e.g., from about 1 to about 10 pounds/ft³. The density preferably ranges from about 1 to about 6 pounds/ft³ and, more preferably, from about 1.5 to about 3 pounds/ft³. The foam sheet 12 preferably has at least about 70% closed cells, more preferably about 80% closed cells and, most preferably, at least about 90% closed cells.

Any conventional chemical or physical blowing agents may be used to produce the foam sheet 12. Preferably, the blowing agent is a physical blowing agent such as carbon dioxide, ethane, propane, n-butane, isobutane, pentane, hexane, butadiene, acetone, methylene chloride, any of the chlorofluorocarbons, hydrochlorofluorocarbons, or hydrofluorocarbons, as well as mixtures thereof.

The blowing agent may be mixed with the polyolefin in any desired amount to achieve a desired degree of expansion in the resultant foam. Generally, the blowing agent may be added to the polyolefin in an amount ranging from about 0.5 to about 80 parts by weight, based on 100 parts by weight of the polyolefin. More preferably, the blowing agent is present at an amount ranging from about 1 to about 30 and, most preferably, from about 3 to about 15 parts per 100 parts by weight of the polyolefin.

If desired or necessary, various additives may also be included with the polyolefin. For example, it may be desirable to include a nucleating agent (e.g., zinc oxide, zirconium oxide, silica, talc, etc.) and/or an aging modifier (e.g., a fatty acid ester, a fatty acid amide, a hydroxyl amide, etc.). Other additives that may be included if desired are pigments, colorants, fillers, antioxidants, flame retardants, stabilizers, fragrances, odor masking agents, and the like.

Foam in accordance with the present invention is preferably made by an extrusion process that is well known in the art. In such a process, the polyolefin is added to an extruder, preferably in the form of resin pellets. Any conventional type of extruder may be used, e.g., single screw, double screw, and/or tandem extruders. In the extruder, the resin pellets are melted and mixed. A blowing agent is preferably added to the melted polyolefin via one or more injection ports in the extruder. Any optional additives that are used may be added to the melted polyolefin in the extruder and/or may be added with the resin pellets. The extruder pushes the entire melt mixture (melted polyolefin, blowing agent, and any optional additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells.

The first film sheet 11 preferably comprises a polyolefin. Suitable polyolefins include, but are not limited to, low density polyethylenes, metallocene based polyethylenes, medium density polyethylenes, high density polyethylenes, and polypropylenes (e.g., biaxially oriented polypropylenes). Various polypropylenes are suitable for first film sheet 11, including atactic, isotactic, syndiotactic, long-chain branched, and propylene/ethylene copolymers.

Preferably, first film sheet 11 is as thin as possible, in order to minimize the amount of resin necessary to produce the film, while providing an acceptably low WVTR for floor underlayment applications. Thus, the first film sheet 11 preferably has a thickness of not more than about 0.001 inches, and more preferably of between about 0.0003 and about 0.00075 inches.

The second film sheet 14 preferably comprises a polyolefin and, more preferably, a low density polyethylene. Second film sheet 14 preferably has a thickness of between about 0.001 inches and about 0.008 inches. More preferably, second film sheet 14 has a thickness of about 0.002 inches.

When the first and/or second film sheets, 11 and 14, comprise polypropylene, the manufacture of the film sheets may be generally accomplished by extruding polypropylene and optionally other resinous materials, which have been heated to their flow or melting point, from an extrusion die in tubular or planar form. After extrusion, or coextrusion where either of the film sheets are a multilayer film, the extrudate is preferably cooled by quenching.

After quenching, the first and/or second film sheets, 11 and 14, are optionally stretch oriented. The term “stretch-oriented” is used herein to describe the process and resultant product characteristics obtained by stretching and immediately cooling a resinous polymeric material which has been heated to its orientation temperature so as to revise the molecular configuration of the material by physical alignment of the molecules to improve certain mechanical properties of the film such as, for example, tensile strength and tear strength, as well as the optical properties of the film. Importantly, in the context of the present invention, stretch-orientation decreases the WVTR of a film, i.e., improves the moisture vapor barrier functionality of the film, and also increases the toughness of the film in comparison to films that are not stretch-oriented.

The first and/or second film sheets, 11 and 14, are optionally stretch-oriented by reheating the quenched film sheet to its orientation temperature and then stretching the film. The orientation temperature for a given film will vary with the different resinous polymers and blends thereof which comprise the film, and will generally be a range of temperatures based on such factors. In general, the orientation temperature may be stated to be above room temperature and below the melting point of the film, and will typically be at or near the glass transition temperature of the resins from which the film is made.

The process of stretching a film at its orientation temperature range may be accomplished in a number of ways such as, e.g., by “blown bubble” or “tenter framing” techniques. These and other techniques are well known in the art and involve stretching the film in the cross or transverse direction (TD) and/or in the longitudinal or machine direction (MD). When the stretching force is applied in one direction, uniaxial orientation results. When the stretching force is applied in two directions, biaxial orientation results. After being stretched, the film is rapidly cooled to quench and thus set or locked-in the oriented molecular configuration. Such an oriented and quenched film is said to be “heat-shrinkable,” i.e., without heat-setting as described immediately below, the film will tend to return toward its original, unoriented (unstretched) dimensions when subsequently heated to an appropriate temperature below its melting temperature range.

After locking-in the oriented molecular configuration by quenching, first and/or second film sheets, 11 and 14, are preferably heat-set by bringing the oriented film to a temperature near its orientation temperature while restraining the film in its stretched dimensions. This process, which is also know as “annealing,” produces a film with substantially less shrinkability, while retaining much of the advantages of orientation, including improved tensile strength and optical properties, as well as lower WVTR.

First and/or second film sheets, 11 and 14, are preferably stretch-oriented in at least two directions, i.e., “biaxially oriented,” preferably in both the machine direction and transverse direction. Further, the first and/or second film sheets preferably have an orientation ratio of at least about 2 in both of the directions in which they have been oriented; more preferably at least about 3, even more preferably at least about 4 and, most preferably, an orientation ratio of at least about 5 in both directions. As used herein, the phrase “orientation ratio” refers to the multiplication product of the extent to which a film is expanded in any one direction during the orientation process. Thus, an orientation ratio of, e.g., 2 in the machine direction, indicates that the film has been expanded to twice its original dimension in the machine direction of the film. When a film is biaxially oriented, the orientation ratios are conventionally expressed as “[machine direction (MD) ratio]×[transverse direction (TD) ratio]” or “[TD ratio]×[MD ratio],” however designated. Thus, a biaxial orientation ratio of 2 in the MD and 3 in the TD would be expressed as a “MD×TD orientation ratio of 2×3.”

To facilitate bonding between the foam sheet 12 and the first and/or second film sheets, 11 and 14, such as when the foam sheet 12 and the film sheets are comprised of chemically dissimilar materials that do not bond well to one another, a bonding layer is optionally interposed between the foam sheet 12 and the first and/or second film sheet, 11 and 14. Toward that end, the first and/or second film sheets, 11 and 14, optionally comprise a film layer 22 and a bonding layer 24. In one embodiment, the film layer 22 and the bonding layer 24 are integrally formed.

Suitable materials from which the bonding layer may be constructed include propylene/ethylene copolymers, ethylene-propylene terpolymers (e.g., EPDM), ethylene-butylene random copolymers, polyethylenes ranging in density from about 0.91 to about 0.96 g/cc, metallocene-catalyzed plastomers and elastomers, ultra low density ethylene/octene copolymers (ranging in density from about 0.88 to about 0.913 g/cc), ionomers, natural rubbers, styrene-butadine-stryrene copolymers, styrene-isoprene-styrene copolymers, acrylics, ethylene/vinyl acetate copolymers, ethylene/vinyl alcohol copolymers, flourinated ethylene-propylene copolymers, elastomeric copolymers of ethylene and propylene (e.g., EPR), butyl rubbers, ABS, chlorinated polyethylenes, PVDC, ACS acrylonitrile-chlorinated polyethylenes, and HIPS (high impact polystyrenes).

Alternatively, the bonding layer may comprise a reactively modified surface produced on the first and/or second film sheets by a suitable means. A “reactively modified surface” is a film surface that has been chemically altered in order to incorporate reactive species onto such film surface in order to improve the ability of such surface to be adhered to another material. Specific examples of reactive surface modification include corona treatment, plasma (ionized gas) treatment, flame treatment, and chemical treatments. As a further alternative, the bonding layer may comprise a combination of the foregoing bonding means, i.e., the bonding layer may comprise one of the bonding materials set forth above with the surface of such layer that is to be in contact with the foam sheet 12 having a reactively modified surface thereon.

A less preferred alternative is to bond the first and/or second film sheets, 11 and 14, and foam sheet 12 together via adhesive lamination, e.g., wherein the bonding layer comprises a pressure-sensitive adhesive or a thermoset adhesive such as a polyurethane adhesive.

An adhesive 25 is optionally positioned along the extended region 19 of the second film sheet 14. In one embodiment, the adhesive 25 is formed as an adhesive layer along at least a portion of the extended region 19 of the second film sheet 14. A release layer is optionally positioned over the adhesive 25 to maintain the integrity of the adhesive until a time just prior to use.

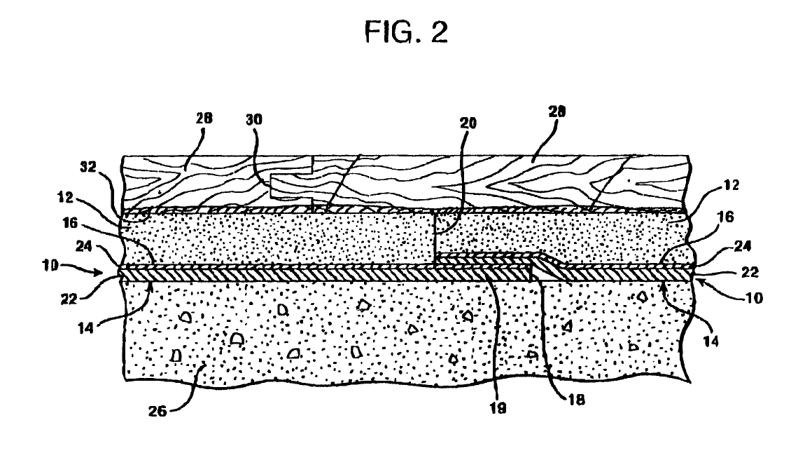

The use of composite structure 10 as a floor underlayment for a laminate floor is shown schematically in FIG. 2. As shown, composite structure 10 is positioned on concrete subflooring 26 in a free-lying manner, i.e., not adhered to the subflooring. Composite structure 10 is in the form of strips, with two adjacent strips being shown in FIG. 2. Second film sheet 14 contacts the top surface of concrete subflooring 26. Planks 28 of laminate flooring, which preferably have the appearance of natural wood flooring, are positioned on composite structure 10 in a free-lying manner. Planks 28 fit together by means of tongue-in-groove arrangement 30 and are preferably glued together (glue not shown). First film sheets 11 contact the bottom surface 32 of laminate flooring planks 28.

FIG. 2 shows that the extended region 19 of second film sheet 14 of one strip of composite structure 10 underlies the adjacent strip of composite structure 10. In this manner, second film sheet 14 provides a continuous water vapor barrier across the entire surface of concrete subflooring 26, i.e., without any gaps as would otherwise occur at the intersection of adjacent strips of the composite structure, thereby protecting the laminate flooring 28 from damage due to exposure to water vapor. The strip of laminate composition 10 which has its extended region 19 against a wall can be, for example, trimmed, cut to fit, or tucked between the composite material 10 and the concrete subflooring 26.

As an alternative, composite structure 10 can be installed so that second film sheet 14 contacts laminate flooring 28 and first film sheet 11 contacts concrete subflooring 26.

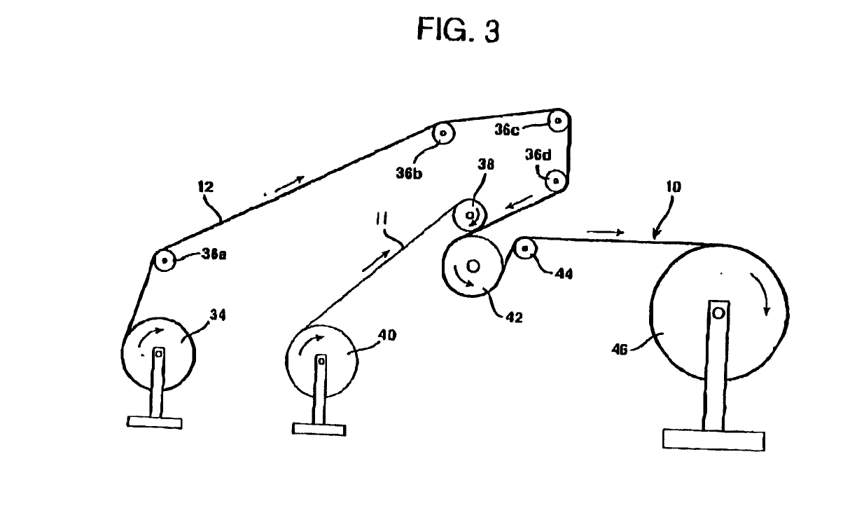

Having now described composite structures in accordance with the invention, a preferred method for making composite structure 10 will be discussed with reference to FIG. 3, which illustrates a method for adhering the first and second film sheets, 11 and 14, to the foam sheet 12 via heat lamination. Foam sheet 12 is unwound from storage roll 34 and sent via guide rollers 36a-d to hot roller 38. Simultaneously, first film sheet 11 is unwound from storage roll 40, wrapped around hot roller 38 to heat the film, then brought into contact with foam sheet 12 between hot roller 38 and contact roller 42. The lamination process is completed by squeezing the foam/film composite between contact roller 42 and chill roller 44, which both presses the film and foam together sufficiently to cause bonding and cools the resultant composite structure 10 to allow further handling thereof. The composite structure 10 is then wound onto storage roll 46. Composite structure 10 is then moved to storage roll 34, the first film sheet 11 at storage roll 40 is replaced with second film sheet 14, and the process is repeated to adhere the second film sheet 14 to the composite structure 10. Once the composite structure 10 is formed, the adhesive and release liner 25 are optionally applied using conventional techniques.

The heat supplied to first and second film sheets, 11 and 14, from hot roller 38 is sufficient to cause the films, 11 and 14, and foam 12 to bond but preferably without melting either the films or the foam. Excess heat from hot roller 38 can result in the complete or partial collapse in the cells of foam sheet 12.

In order to provide second film sheet 14 with extended region 19, the second film sheet 14 is preferably wider than foam sheet 12 so that edge 18 of the second film sheet 14 extends beyond a corresponding edge 20 of the foam sheet 12. The widths of both the foam sheet 12 and second film sheet 14 may range, for example, between about 20 and about 200 inches. The amount that edge 18 of second film sheet 14 extends beyond corresponding edge 20 of foam sheet 12 is not critical and may be any desired amount, e.g., between about 1 and about 10 inches. Thus, if the width of foam sheet 12 is 60 inches, for example, the width of second film sheet 14 may be 64 inches so that the extended region is 4 inches in width.

These and other aspects and advantages of the invention may be further understood by reference to the following examples, which are provided for illustrative purposes only and are not intended in any way to be limiting.

### EXAMPLES

For each of the examples below, polyolefin foam sheets were made by blending, in a tandem extruder, LDPE resin having a density of 0.918 g/cc and a melt index of 2 g/10 min., talc, a mixture containing glycerol monostearate and ethanolamide, and butane as a blowing agent. The mixture was extruded out of an annular die, whereupon it expanded into a foam tube and the tube was slit to form a sheet. The resultant foam sheet had a thickness of about 0.075 inch and a density of about 2 pounds/ft³ (pcf).

### Example 1

A 0.0005 inch thick metallocene based HDPE film sheet was laminated to one side surface of the resultant foam sheet by contacting the film with a heated roller maintained at 320° F. and then pressing the film and foam sheet together between the heated roller and a rubber roller, as described above with reference to FIG. 3. The metallocene-based HDPE film sheet offers good elasticity and flexibility. The width of the film sheet was the same as that of the foam sheet so that a portion of the film sheet covers the foam sheet completely from edge to edge. For convenience, this laminated film/foam composite will be referred to as the “base film.” A second film having a thickness of 0.002 inches was then laminated to the opposite surface of the foam sheet by contacting the film with a heated roller maintained at 380° F. and then pressing the film and foam sheet together between the heated roller and a rubber roller, as described above in connection with the lamination of the first film and foam sheet. The width of the second film sheet was greater than that of the foam sheet so that a portion of the second film sheet extended beyond the foam sheet by 4 inches. For purposes of the following discussions, this second film will be referred to as the “extension film.” A homogeneous glue carried on a release liner was adhered to the edge portion of the composite structure. Upon releasing the liner material, the glue is exposed for adhering the edge portion to an adjacent strip of extension film.

### Comparative Example A

A 0.002 inch thick HDPE film sheet was laminated to one surface of the foam sheet by contacting the film with a heated roller maintained at 380° F. and then pressing the film and foam sheet together between the heated roller and a rubber roller as described above with reference to FIG. 3. The width of the film sheet was greater than that of the foam sheet so that a portion of the film sheet extended beyond the foam sheet by 4 inches. A homogeneous glue carried on a release liner was adhered to the edge portion of the composite structure.

Each of the foregoing composites was tested for moisture vapor transmission rate (MVTR) in accordance with ASTM F 1249-90. The results are summarized in Table 1.

TABLE 1

| | | MVTR | |
|---|---|---|---|
| | | (g/100 inch²/24 hrs at | % Improve- |
| | | 100° F. and 90% | ment over |
| Example | Description | relative humidity) | Comp. Ex. A |
| Ex. 1 | Film/Foam/Film | 0.163 | 12.8% |
| | laminate | | |
| Comp. Ex. A | Foam/Film | 0.187 | N/A |
| | laminate | | |

Each of the foregoing composites was also tested for tensile strength in accordance with ASTM D624-91. The results obtained in the Machine Direction (MD) and Cross-Machine Direction (CMD) are summarized in Tables 2 and 3, respectively.

TABLE 2

| | | | % Improvement |
|---|---|---|---|
| | | Tensile Strength | over |
| Example | Description | (lbf/inch² in MD) | Comp. Ex. A |
| Ex. 1 | Film/Foam/Film | 196.6 | 16.2% |
| | laminate | | |
| Comp. Ex. A | Foam/Film | 169.2 | N/A |
| | laminate | | |

TABLE 3

| | | | % Improvement |
|---|---|---|---|
| | | Tensile Strength | over |
| Example | Description | (lbf/inch² in CMD) | Comp. Ex. A |
| Ex. 1 | Film/Foam/Film | 134.7 | 23.1% |
| | laminate | | |
| Comp. Ex. A | Foam/Film | 109.4 | N/A |
| | laminate | | |

Each of the foregoing composites was also tested for tear resistance properties in accordance with ASTM D412-92. The results are summarized in Tables 4 and 5, respectively.

TABLE 4

| | | | % Improvement |
|---|---|---|---|
| | | Tensile Resistance | over |
| Example | Description | (lb/inch in MD) | Comp. Ex. A |
| Ex. 1 | Film/Foam/Film | 30.1 | 7.1% |
| | laminate | | |
| Comp. Ex. A | Foam/Film | 28.1 | N/A |
| | laminate | | |

TABLE 5

| | | | % Improvement |
|---|---|---|---|
| | | Tensile Resistance | over |
| Example | Description | (lb./inch in CMD) | Comp. Ex. A |
| Ex. 1 | Film/Foam/Film | 53.9 | 18.2% |
| | Laminate | | |
| Comp. Ex. A | Foam/Film | 45.6 | N/A |
| | laminate | | |

The data of Tables 1-5 show that the film/foam/film composite material of Ex. 1 exhibits improved moisture vapor transmission rate, tensile strength, and tear resistance as compared to the foam/film composite material of Comparative Ex. A.

What is claimed is:

1. A composite flooring material comprising:
a. a foam sheet comprising polyolefin;
b. a first film adhered to a first surface of the foam sheet; and
c. a second film adhered to a second surface of the foam sheet, wherein at least one edge of the second film extends beyond a corresponding edge of the foam sheet.

2. The composite material of claim 1 wherein the foam sheet comprises polyethylene.

3. The composite material of claim 2 wherein the foam sheet comprises a low density polyethylene, a medium density polyethylene, or a high density polyethylene.

4. The composite material of claim 1 wherein the foam sheet has a density of between about 1 and about 8 pounds/ft³.

5. The composite material of claim 1 wherein the foam sheet has a thickness of between about 0.001 and about 2 inches.

6. The composite material of claim 1 wherein the first film has a thickness of not more than about 0.001 inches.

7. The composite material of claim 6 wherein the first film has a thickness of between about 0.0003 inches and about 0.00075 inches.

8. The composite material of claim 1 wherein the first film comprises polyolefin.

9. The composite material of claim 8 wherein the first film comprises polyethylene.

10. The composite material of claim 9 wherein the first film comprises a compound selected from the group consisting of low density polyethylene, metallocene based polyethylene, medium density polyethylene, high density polyethylene, and biaxially oriented polypropylene.

11. The composite material of claim 1 wherein the first film comprises a film layer and a bonding layer.

12. The composite material of claim 11 wherein the bonding layer comprises comprises a compound selected from the group consisting of propylene/ethylene copolymers, ethylene-propylene terpolymers, ethylene-butylene random copolymers, polyethylenes ranging in density from about 0.91 to about 0.96 g/cc, metallocene-catalyzed plastomers and elastomers, ultra low density ethylene/octene copolymers ranging in density from about 0.88 to about 0.913 g/cc, ionomers, natural rubbers, styrene-butadine-stryrene copolymers, styrene-isoprene-styrene copolymers, acrylics, ethylene/vinyl acetate copolymers, ethylene/vinyl alcohol copolymers, flourinated ethylene-propylene copolymers, elastomeric copolymers of ethylene and propylene, butyl rubbers, ABS, chlorinated polyethylenes, PVDC, ACS acrylonitrile-chlorinated polyethylenes, and high impact polystyrenes.

13. The composite material of claim 1 wherein the first film is stretch-oriented in at least two directions.

14. The composite material of claim 13 wherein the first film has an orientation ratio of at least about 2 in both of said at least two directions.

15. The composite material of claim 1 wherein the second film has a thickness of between about 0.001 inches and about 0.008 inches.

16. The composite material of claim 15 wherein the second film has a thickness of about 0.002 inches.

17. The composite material of claim 1 wherein the second film comprises polyolefin.

18. The composite material of claim 17 wherein the second film comprises polyethylene.

19. The composite material of claim 18 wherein the second film comprises a low density polyethylene.

20. The composite material of claim 1 wherein the second film comprises a film layer and a bonding layer.

21. The composite material of claim 20 wherein the bonding layer comprises a compound selected from the group consisting of propylene/ethylene copolymers, ethylene-propylene terpolymers, ethylene-butylene random copolymers, polyethylenes ranging in density from about 0.91 to about 0.96 g/cc, metallocene-catalyzed plastomers and elastomers, ultra low density ethylene/octene copolymers ranging in density from about 0.87 to about 0.913 g/cc, ionomers, natural rubbers, styrene-butadine-stryrene copolymers, styrene-isoprene-styrene copolymers, acrylics, ethylene/vinyl acetate copolymers, ethylene/vinyl alcohol copolymers, flourinated ethylene-propylene copolymers, elastomeric copolymers of ethylene and propylene, butyl rubbers, ABS, chlorinated polyethylenes, PVDC, ACS acrylonitrile-chlorinated polyethylenes, and high impact polystyrenes.

22. The composite material of claim 1 further comprising an adhesive positioned along at least a portion of said at least one edge of the second film that extends beyond the corresponding edge of the foam sheet.

23. The composite material of claim 22 further comprising a release liner applied to the adhesive layer.

24. A method for making a composite material comprising the steps of:
a. adhering a first film to a first surface of a foam sheet; and
b. adhering a second film to a second surface of the foam sheet such that at least one edge of the film extends beyond a corresponding edge of the foam sheet.

25. The method of claim 24 wherein the first and second films are heat laminated to the foam sheet.

26. The method of claim 24 comprising the step of interposing a first bonding layer between the first film and the foam sheet.

27. The method of claim 24 comprising the step of interposing a second bonding layer between the second film and the foam sheet.
